(19) United States
(12) Patent Application Publication
(10) Pub. No.: US 2014/0159960 A1
(43) Pub. Date: Jun. 12, 2014

(54) MARINE NAVIGATION BEACON

(71) Applicant: TIDELAND SIGNAL CORPORATION, Houston, TX (US)

(72) Inventor: Paul F. MUELLER, Houston, TX (US)

(73) Assignee: TIDELAND SIGNAL CORPORATION, Houston, TX (US)

(21) Appl. No.: 13/708,386

(22) Filed: Dec. 7, 2012

(51) Int. Cl. G01S 1/68

(52) U.S. Cl. CPC G01S 1/68
USPC 342/385; 29/600; 29/601

(57) ABSTRACT

A marine navigation beacon comprises a first module and a second module disposed within a housing. The first module is configured to transmit a signal having a frequency of less than 1 GHz. The second module is configured to transmit a signal having a frequency of greater than 1 GHz.

### CROSS-REFERENCE TO RELATED APPLICATIONS

None

### BACKGROUND

This disclosure relates generally to methods and apparatus for providing navigational aids to marine vessels. In particular, this disclosure relates to electronic navigational aids, or aids to navigation, that utilize radio, radar, and other electromagnetic signals to provide navigational information to marine vessels.

Aids to navigation are markers or other devices that provide information to the navigator of a vessel to assist the navigator in determining and maintaining a safe course of travel. Aids to navigation include buoys, light houses, markers, lights, horns, and electronic devices. Electronic devices can include radar transponders, which are known as racons, and other radio-frequency devices, such as those that utilize the automatic identification system (AIS).

Marine racons are often mounted to buoys, lighthouses, bridges, and other structures to mark a navigational hazard or other navigational point. Racons operate by receiving a radar pulse from a vessel's radar and responding with a coded radar pulse. The vessel receives the coded radar pulse and can use the coded radar pulse to identify the racon. Marine racons generally operate in both X-band and S-band radar frequencies.

AIS devices can be mounted to both navigational aids and vessels. AIS devices utilize VHF transceivers to broadcast and receive radio transmissions that can include identification, position, course, speed, and other information. This information is exchanged between vessels and/or aids to navigation to provide enhanced information to vessel navigators.

As the use of both AIS systems and radar navigation systems become more widespread, it may often be desirable to provide aids to navigation that have both racons and AIS devices. Having both a racon and an AIS device, allows the utilization of both radar and VHF based methods of communication. Once challenge to providing this functionality is that many aids to navigation may have limited space and/or power available to accommodate both a racon and an

AIS device, and their associated antennas.

Thus, there is a continuing need in the art for methods and apparatus that provide radar-based and VHF based communication systems that overcome these and other limitations of the prior art.

### BRIEF SUMMARY OF THE DISCLOSURE

A marine navigation beacon comprises a first module and a second module disposed within a housing. The first module is configured to transmit a signal having a frequency of less than 1 GHz. The second module is configured to transmit a signal having a frequency of greater than 1 GHz.

### BRIEF DESCRIPTION OF THE DRAWINGS

For a more detailed description of the embodiments of the present disclosure, reference will now be made to the accompanying drawings, wherein:

FIG. 1 is a partial sectional view of an aid to navigation beacon including both radar and VHF based communication equipment.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

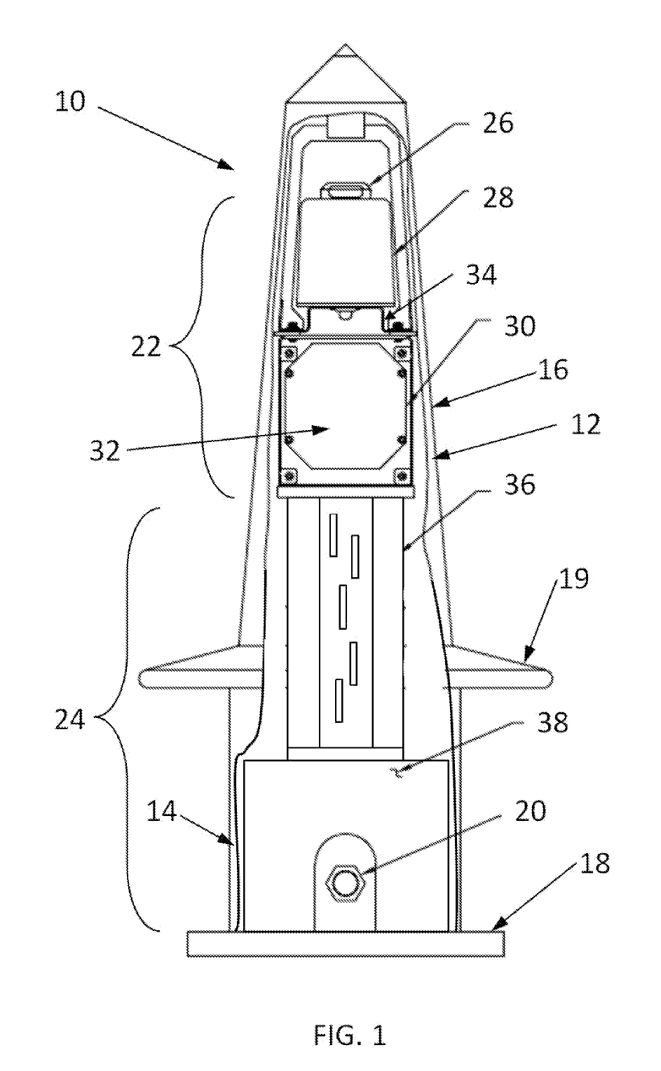

Referring now to FIG. 1, a marine navigation beacon 10 comprises a unitary housing 12 having a cylindrical base portion 14 and a conical upper portion 16. A mounting flange 18 extends outward from the cylindrical base portion 14 to provide a location for coupling the beacon 10 to a horizontal mounting surface. A lift ring 19 extends outward from the housing 12 to provide a handling feature for lifting and moving the beacon 10. An access port 20 is disposed in the cylindrical base portion 14 to provide access to the interior of the beacon 10 for a power and/or data coupling. The housing 12 may be constructed from a material that minimizes interference with electromagnetic signals travelling through the housing and protects the interior of the housing from environmental conditions. In certain embodiments, housing 12 may be pressurized with an inert gas, such as nitrogen, to further protect the interior of the housing from the environment. To enable pressurization the port 20 may include sealing elements.

The housing 12 is sized so as to enclose the operating components of the navigation beacon 10, including an AIS, or first, module 22 and a racon, or second, module 24. In certain embodiments, the overall height of the housing 12 may be between 30 and 36 inches or between 31 and 32 inches. The maximum outer diameter of the housing 12 may be between 12 and 18 inches or between 13 and 14 inches. AIS module 22 and racon module 24 may be assembled into a single unit prior to installation into the housing 12.

AIS module 22 comprises a GPS antenna 26, VHF antenna 28, and an AIS electronics package 30. The AIS electronics package 30 may be disposed within an enclosure 32, which in certain applications can provide additional protection from environmental elements. GPS antenna 26 is mounted to the upper end of the VHF antenna 28, which is mounted to a frame 34 that is coupled to the AIS electronics package enclosure 32. Both the GPS antenna 26 and the VHF antenna 28 are operably coupled to the AIS electronics package 30. The AIS electronics package 30 may be operable to only transmit signals or to both transmit and receive signals, such as an AIS repeater. The AIS electronics package 30 may be programmable so that the message relayed by the AIS module 22 can be customized to include information desired by an end user. The AIS module 22 may be configured to transmit and/or receive signals at a frequency of less than 1 GHz and a wavelength of greater than 0.3 m. The GPS antenna 26 may be configured to receive signals at a frequency of about 1.5 GHz.

Racon module 24 comprises a racon antenna 36 and a racon electronics package 38. The racon antenna 36 includes an upper flange 40 onto which the AIS electronics package 30 is mounted. Racon module 24 may be configured to operate in a single radar band so as to reduce the size and/or complexity of the racon antenna 36 and the racon electronics package 38. In certain embodiments, the racon module 24 may be configured to operate within only the X-band spectrum. Utilizing a single radar band allows the racon antenna 36 to be a single antenna optimized for use with the selected band of radar. The racon module 24 may be configured to transmit and/or receive signals at a frequency of greater than 1 GHz and a wavelength of less than 0.3 m.

Both AIS module 22 and racon module 24 are electrically coupled to the access port 20 that allows the modules to be coupled to a power supply or to exchange data with components located outside the housing 12. For example, an external controller can be coupled to the port 20 and used to program the AIS module 22 and/or the racon module 24. In certain embodiments, port 20 may also allow the AIS module 22 and/or the racon module 24 to receive data from external sources, which can then be transmitted by the AIS module and/or the racon module.

While the disclosure is susceptible to various modifications and alternative forms, specific embodiments thereof are shown by way of example in the drawings and description. It should be understood, however, that the drawings and detailed description thereto are not intended to limit the disclosure to the particular form disclosed, but on the contrary, the intention is to cover all modifications, equivalents and alternatives falling within the spirit and scope of the present disclosure.

What is claimed is:

1. A marine navigation beacon comprising:
a housing;
a first module disposed within the housing and configured to transmit a signal having a frequency of less than 1 GHz; and
a second module disposed within the housing and configured to transmit a signal having a frequency of greater than 1 GHz.

2. The marine navigation beacon of claim 1, wherein the first module further comprises:
a first antenna; and
an electronics package operatively coupled to the first antenna.

3. The marine navigation beacon of claim 2, wherein the first module further comprises a second antenna operatively coupled to the electronics package.

4. The marine navigation beacon of claim 3, wherein the first antenna is a VHF antenna and the second antenna is a GPS antenna.

5. The marine navigation beacon of claim 1, wherein the second module further comprises:
a racon antenna; and
a racon electronics package.

6. The marine navigation beacon of claim 5, wherein the racon antenna is an X-band antenna.

7. The marine navigation beacon of claim 1, wherein the housing has a height of less than 36 inches and a maximum diameter of less than 18 inches.

8. A marine navigation beacon comprising:
a first module configured to transmit a signal having a frequency of less than 1 GHz;
a second module configured to transmit a signal having a frequency of greater than 1 GHz, wherein the first module is mounted to an upper end of the second module; and
a housing substantially surrounding the first and second modules.

9. The marine navigation beacon of claim 8, wherein the first module further comprises:
a first antenna; and
an electronics package operatively coupled to the first antenna.

10. The marine navigation beacon of claim 9, wherein the first module further comprises a second antenna operatively coupled to the electronics package.

11. The marine navigation beacon of claim 10, wherein the first antenna is a VHF antenna and the second antenna is a GPS antenna.

12. The marine navigation beacon of claim 9, wherein the second module further comprises:
a racon antenna; and
a racon electronics package.

13. The marine navigation beacon of claim 12, wherein the racon antenna is an X-band antenna.

14. The marine navigation beacon of claim 12, wherein the electronics package of the first module is coupled to the racon antenna of the second module.

15. The marine navigation beacon of claim 8, wherein the housing has a height of less than 36 inches and a maximum diameter of less than 18 inches.

16. A method of assembling a marine navigation beacon comprising:
coupling a first module to the upper end of a second module, wherein the first module is configured to transmit a signal having a frequency of less than 1 GHz and the second module is configured to transmit a signal having a frequency of greater than 1 GHz; and
disposing the first and second modules within a housing.

17. The method of claim 16, further comprising assembling the first module by coupling a first antenna and a second antenna to an electronics package.

18. The method of claim 17, further comprising assembling the second module by coupling a racon antenna to a racon electronics package.

19. The method of claim 18, wherein the electronics package of the first module is coupled to the racon antenna of the second module.

20. The method of claim 18, wherein the first antenna is a VHF antenna, the second antenna is a GPS antenna, and the racon antenna is an X-band antenna.
